(19) United States
(12) Patent Application Publication
(10) Pub. No.: US 2012/0120840 A1
(43) Pub. Date: May 17, 2012

(54) Adjusting Method for Downlink Modulation Coding Mode and Multiple-Input-Multiple-Output Mode and Device

(75) Inventor: Guang Liu, Shenzhen (CN)

(73) Assignee: ZTE CORPORATION, Shenzhen City, Guangdong Province (CN)

(21) Appl. No.: 13/383,280

(22) PCT Filed: Jun. 11, 2010
(86) PCT No.: PCT/CN2010/073826

§ 371 Date: Jan. 10, 2012

(30) Foreign Application Priority Data
Aug. 4, 2009 (CN) 200910090269.2

(51) Int. Cl. H04W 24/00; H04L 12/26; H04W 92/00

(52) U.S. Cl. 370/252; 370/338

(57) ABSTRACT

An adjustment method for downlink modulation and coding scheme and multiple-input-multiple-output mode (MIMO) and a base station thereof are provided. The method comprises: establishing a corresponding relationship table of data transmission rates and combinations of said downlink scheme and MIMO; determining maximal available modulation and coding scheme according to the downlink carrier-to-interference-and-noise-ratio (CINR) reported by a terminal, switching current downlink scheme to the maximal available scheme when the current downlink scheme is greater than the maximal available scheme; collecting the total number of data packets and the number of valid data packets in the data packets in every report period; and adjusting the current downlink scheme and MIMO according to the maximal available scheme and said table when determining that the current downlink scheme and MIMO are not suitable for the current channel conditions in accordance with the total number of data packets and the number of valid data packets.

### TECHNICAL FIELD

The present invention relates to the field of mobile communications, and more especially, to an adjusting method for downlink modulation and coding scheme and multiple-input multiple-output mode and a base station device thereof.

2. Background of the Related Art

Multiple Input and Multiple Output (MIMO) technology refers to the technology using multiple antennas for transmission/reception in the transmitter/receiver; it is a research hotspot in the multi-antenna technology in the field of wireless mobile antennas and is one of key technologies used in the next generation of mobile communications system. This technology uses multi-path technology to protect the channel from each kind of random fading and to effectively avoid co-channel interference, to improve the channel quality, and further to improve the network reliability and communications service quality; with the use of space resources, the system capacity and spectral efficiency can be exponentially increased in theory without consuming extra air interface resources (time, frequency).

The MIMO technology mainly has two kinds of applications: diversity Space Time Coding (STC), which includes transmit diversity and receive diversity, and Spatial Multiplexing (SM).

The Diversity STC technology takes advantage of time and space simultaneously, it enhances the diversity and coding gain rather than system capacity, and its principle is shown in FIG. 1. As shown in FIG. 1, the input characters, that is, the information sources, are divided into two groups, each group has two characters. In the first character time, the two characters [C1, C2] in each group are transmitted from two antennas at the same time, and in the next character time, these two characters are transformed as [−C2*, C1*] and transmitted again from the two antennas. Therefore, the receiving antennas can receive the two characters in two different forms within two-character time, compared with the scheme that only one form of the two characters is received in two-character time, the accuracy of the characters decoded in the scheme that two forms of the two characters are received in two-character time is greatly improved, thus reducing bit error rate, improving the link reliability and further increasing the signal coverage. When the coverage and the bit error rate requirement are constant, the diversity gain can be turned into the increase of data transmission rate, such as applying a higher modulation and coding scheme.

The spatial multiplexing technology uses the space, as shown in FIG. 2, a high-speed data stream is divided into parallel data streams to be transmitted at the same time, the transmission data of each antenna are different, and then the data are spatially de-multiplexed at the receiver and re-combined into a high-speed serial data stream. Using this method, the system transmission rate and throughput can be increased greatly.

As the wireless channel changes in real time, at some time points, using diversity STC can get a better channel gain and improve the link transmission reliability; at some other time points, using the SM technology can improve the channel transmission rate, thereby improving the channel throughput. Using the diversity STC or SM technology alone cannot maximally utilize the limited frequency resources.

Adaptive Modulation and Coding (AMC) in the wireless communications is a selective link adaptation method, and the AMC provides flexibility to cope with the modulation and coding scheme to allow each user meet the average channel conditions. This is because the AMC modulation and coding format is changed to conform to the current received signal quality or channel conditions. The downlink AMC is usually achieved in non-MIMO or MIMO space-time coding mode.

In the related art, the process for selecting the downlink modulation and coding scheme and the MIMO mode is as follows: the AMC module in the base station uses the downlink carrier-to-interference-and-noise-ratio (CINR) reported by the terminal to decide the downlink modulation and coding scheme, the hybrid automatic repeat request (HARM) module in the base station uses the packet information fed back by the terminal to determine the MIMO mode, that is, the downlink modulation and coding scheme and the downlink MIMO mode are decided and judged separately. The disadvantages of the related art are: in the data transmission process, since the adjustment range of the downlink modulation and coding scheme and the MIMO mode is relatively small, it is possible that the link reliability is guaranteed but the throughput is not increased, or the theoretical throughput is increased but the link reliability can not be guaranteed, resulting in the actual throughput decrease.

### SUMMARY OF THE INVENTION

The present invention provides a method and device for adjusting the downlink modulation and coding scheme and the multiple input multiple output (MIMO) mode so that the current downlink modulation and coding scheme and the MIMO mode are suitable to the current channel conditions, thereby improving the link reliability and system throughput.

To solve the above technical problem, the technical scheme provided in the present invention is as follows:

A method for adjusting downlink modulation and coding scheme and multiple input multiple output (MIMO) mode, comprising:

establishing a corresponding relationship table which lists the corresponding relationships between the data transmission rates and the combinations of the downlink modulation and coding schemes and the MIMO modes, and sorting the data transmission rates in the corresponding relationship table according to the order from small to large;

determining the maximal available modulation and coding scheme according to the downlink carrier-to-interference-and-noise-ratio reported by the terminal, and when the modulation and coding scheme currently in use is greater than the maximal available modulation and coding scheme, switching the downlink modulation and coding scheme currently in use to the maximal available modulation and coding scheme, and switching the MIMO mode currently in use to the space-time coding mode;

collecting the total number of packets in each report period and the number of valid data packets in the total packets; and

judging whether the current downlink modulation and coding scheme and the MIMO mode are suitable for the current channel conditions or not according to the total number of packets and the number of valid packets, and adjusting the downlink modulation and coding scheme and the MIMO mode currently in use according to the maximal available modulation and coding scheme described above and the corresponding relationship table when determining that the current downlink modulation and coding scheme and the MIMO mode are not suitable for the current channel conditions.

In the aforementioned adjustment method, the steps for judging whether the current downlink modulation and coding scheme and the MIMO mode are suitable for the current channel conditions or not according to the total number of packets and the number of valid packets, and adjusting the downlink modulation and coding scheme and the MIMO mode currently in use according to the maximal available modulation and coding scheme described above and the corresponding relationship table when determining that the current downlink modulation and coding scheme and the MIMO mode are not suitable for the current channel conditions comprise: calculating the ratio of the number of valid packets to the total number of packets in each report period in the first switching decision period to acquire the first radio;

collecting the times that the first ratio is greater than the first threshold to acquire the first times; and

when the first times reaches to the first switching threshold, determining that the current downlink modulation and coding scheme and the MIMO mode are not suitable for the current channel conditions, searching the corresponding relationship table downwardly to find the entries whose data transmission rates are greater than the current data transmission rate and downlink modulation and coding scheme is no greater than the maximal available modulation and coding scheme, and switching the current downlink modulation and coding scheme and the MIMO mode to the downlink modulation and coding scheme and the MIMO mode in the first found entry.

In the aforementioned adjustment method, the steps for judging whether the current downlink modulation and coding scheme and the MIMO mode are suitable for the current channel conditions or not according to the total number of packets and the number of valid packets, and adjusting the downlink modulation and coding scheme and the MIMO mode currently in use according to the maximal available modulation and coding scheme described above and the corresponding relationship table when determining that the current downlink modulation and coding scheme and the MIMO mode are not suitable for the current channel conditions also comprise: calculating the ratio of the number of valid packets to the total number of packets in each report period in the second switching decision period to acquire the second radio;

collecting the times that the second ratio is less than the second threshold to acquire the second times; and

When the second times reaches to the second switching threshold, determining that the current downlink modulation and coding scheme and the MIMO mode are not suitable for the current channel conditions, searching the corresponding relationship table upwardly to find the entries whose data transmission rates are lower than the current data transmission rate and downlink modulation and coding scheme is no greater than the maximal available modulation and coding scheme, and switching the current downlink modulation and coding scheme and the MIMO mode to the downlink modulation and coding scheme and the MIMO mode in the first found entry.

In the aforementioned adjustment method, the steps for judging whether the current downlink modulation and coding scheme and the MIMO mode are suitable for the current channel conditions or not according to the total number of packets and the number of valid packets, and adjusting the downlink modulation and coding scheme and the MIMO mode currently in use according to the maximal available modulation and coding scheme described above and the corresponding relationship table when determining that the current downlink modulation and coding scheme and the MIMO mode are not suitable for the current channel conditions also comprise:

collecting the times that the number of packets is zero to acquire the third times; and

When the third times reaches to the third switching threshold, determining that the current downlink modulation and coding scheme and the MIMO mode are not suitable for the current channel conditions, searching the corresponding relationship table upwardly to find the entries whose data transmission rates are lower than the current data transmission rate and downlink modulation and coding scheme is no greater than the maximal available modulation and coding scheme, and switching the current downlink modulation and coding scheme and the MIMO mode to the downlink modulation and coding scheme and the MIMO mode in the first found entry.

The aforementioned adjustment method, wherein, the first switching decision period is greater than the second switching decision period.

In the aforementioned adjustment method, the total number of data packets is the number of non-retransmitted packets collected by the base station in one report period.

One base station device, comprising:

a corresponding relationship table creation module, configured for creating a corresponding relationship table of the data transmission rates and the combinations of the downlink modulation and coding schemes and the MIMO modes, and sorting the data transmission rates in the corresponding relationship table in the order from small to large;

an Adaptive Modulation and Coding (AMC) module, configured for determining the maximal available modulation and coding scheme according to the downlink carrier-to-interference-and-noise-ratio reported by the terminal, and when the modulation and coding scheme currently in use is greater than the maximal available modulation and coding scheme, switching the downlink modulation and coding scheme currently in use to the maximal available modulation and coding scheme, and switching the MIMO mode currently in use to the space-time coding mode;

a hybrid automatic repeat request module, configured for collecting the total number of packets in each report period and the number of valid data packets in the total packets; and

a joint adjustment module, configured for judging whether the current downlink modulation and coding scheme and the MIMO mode are suitable for the current channel conditions or not according to the total number of packets and the number of valid packets, and when determining that the current downlink modulation and coding scheme and the MIMO mode are not suitable for the current channel conditions, adjusting the downlink modulation and coding scheme and the MIMO mode currently in use according to the maximal available modulation and coding scheme described above and the corresponding relationship table.

Wherein, the joint adjustment module comprises:

a first ratio calculation unit, configured for calculating the ratio of the number of valid packets to the total number of packets in each report period in the first switching decision period to acquire the first ratio;

a first times calculation unit, configured for collecting the times that the first ratio is greater than the first threshold to acquire the first times; and

a first adjustment unit, configured for: when the first times reaches to the first switching threshold, determining that the current downlink modulation and coding scheme and the MIMO mode are not suitable for the current channel conditions, searching the corresponding relationship table downwardly to find the entries whose data transmission rates are greater than the current data transmission rate and downlink modulation and coding scheme is no greater than the maximal available modulation and coding scheme, and switching the current downlink modulation and coding scheme and the MIMO mode to the downlink modulation and coding scheme and the MIMO mode in the first found entry.

The joint adjustment module also comprises:

a second ratio calculation unit, configured for calculating the ratio of the number of valid packets to the total number of packets in each report period in the second switching decision period to acquire the second ratio;

a second times calculation unit, configured for collecting the times that the second ratio is less than the second threshold to acquire the second times; and

a second adjustment unit, configured for: when the second times reaches to the second switching threshold, determining that the current downlink modulation and coding scheme and the MIMO mode are not suitable for the current channel conditions, searching the corresponding relationship table upwardly to find the entries whose data transmission rates are lower than the current data transmission rate and downlink modulation and coding scheme is no greater than the maximal available modulation and coding scheme, and switching the current downlink modulation and coding scheme and the MIMO mode to the downlink modulation and coding scheme and the MIMO mode in the first found entry.

The joint adjustment module also comprises:

a third times calculation unit, configured for collecting the times that the total number of packets is continuously zero to acquire the third times; and

a third adjustment unit, configured for: when the third times reaches to the third switching threshold, determining that the current downlink modulation and coding scheme and the MIMO mode are not suitable for the current channel conditions, searching the corresponding relationship table upwardly to find the entries whose data transmission rates are lower than the current data transmission rate and downlink modulation and coding scheme is no greater than the maximal available modulation and coding scheme, and switching the current downlink modulation and coding scheme and the MIMO mode to the downlink modulation and coding scheme and the MIMO mode in the first found entry.

The embodiments of the present invention use the HARQ technology to judge whether the current downlink modulation and coding scheme and the downlink MIMO mode are suitable for the current channel conditions or not, and jointly adjust the downlink modulation and coding scheme and the downlink MIMO mode according to the judgment result so that the current downlink modulation and coding scheme and the MIMO mode are suitable for the current channel conditions, thus improve the link reliability and system throughput.

### BRIEF DESCRIPTION OF DRAWINGS

FIG. 1 is a schematic diagram of space-time coding;

FIG. 2 is a schematic diagram of spatial multiplexing;

FIG. 3 is a flow chart of the method for adjusting the downlink modulation and coding scheme and the MIMO mode in accordance with the present invention;

FIG. 4 is a flow chart of executing the adjustment method in the switching decision period T_{UP} in accordance with the present invention;

FIG. 5 is a flow chart of executing the adjustment method in the switching decision period T_{DOWN} in accordance with the present invention;

FIG. 6 is a schematic diagram of the base station device in accordance with an embodiment of the present invention;

FIG. 7 is a structural diagram of the joint adjustment module in the aforementioned base station device.

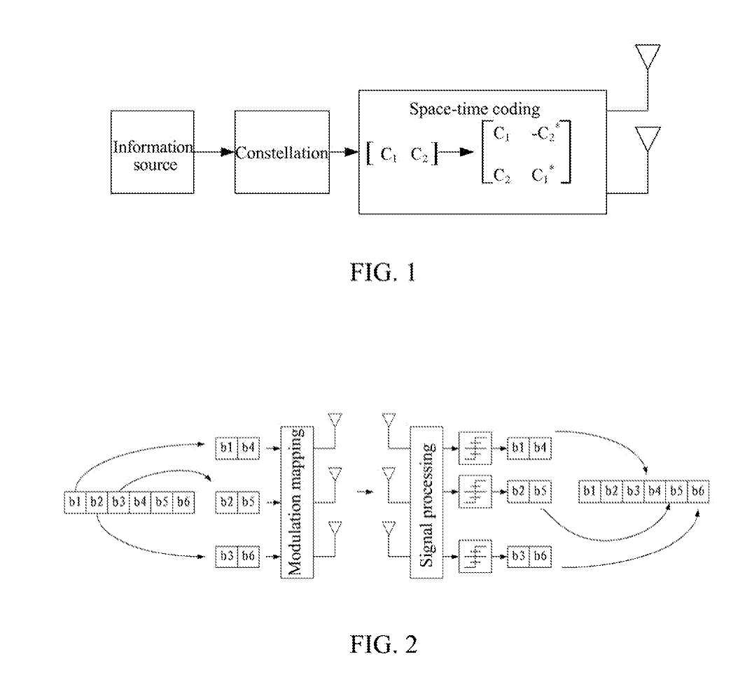

### PREFERRED EMBODIMENTS OF THE PRESENT INVENTION

To better understand the present invention, first of all, the hybrid automatic repeat request (HARQ) technology is introduced.

The HARQ technology is a physical layer technology developed on the basis of the automatic repeat request (ARQ) technology, and it combines the conventional ARQ technology and the forward error correction (FEC) technology, the sender uses FEC coding to send information, the error in the information received by the receiver can be self-corrected when the number of error bits is within the error correction capability; when the error is too serious to be corrected, it requests retransmission. Since multiple retransmissions are applied, the HARQ technology is able to offset the impact due to the change of the channel conditions, so as to effectively improve the transmission efficiency and reliability.

The retransmission mechanism in the HARQ technology, to some extent, reflects whether the current downlink modulation and coding scheme and downlink MIMO mode are suitable for the current wireless channel conditions. If there are a lot of packets needed to be retransmitted in a certain time period, or there are a lot of packets unsuccessfully transmitted, it means that the current downlink modulation and coding scheme and the downlink MIMO mode are not suitable for the current channel conditions; on the contrary, if the packet correct rate is very high in a certain time period, almost no corrections or retransmissions are needed, it means that the current downlink modulation and coding scheme and the downlink MIMO mode are suitable for the current channel conditions.

Therefore, the embodiments of the present invention use the HARQ technology to judge whether the current downlink modulation and coding scheme and the downlink MIMO mode are suitable for the current channel conditions or not, and to jointly adjust the downlink modulation and coding scheme and the downlink MIMO mode according to the judgment result.

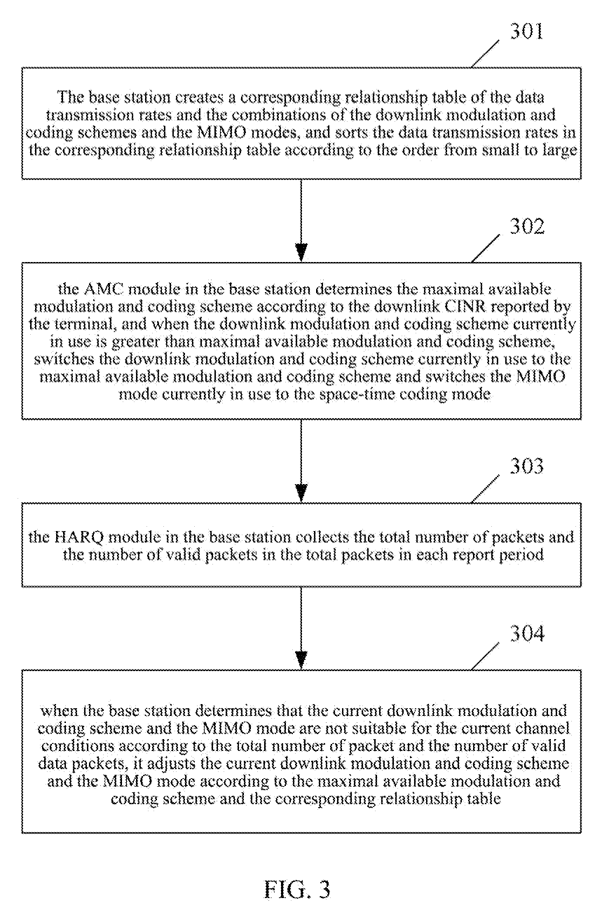

Refer to FIG. 3, the method for adjusting the downlink modulation and coding scheme and the MIMO code in accordance with the present invention mainly comprises the following steps:

Step 301: the base station creates a corresponding relationship table of the data transmission rates and the combinations of the downlink modulation and coding schemes and the MIMO modes, and sorting the data transmission rates in the corresponding relationship table according to the order from small to large;

When the modulation and coding scheme and the MIMO mode are fixed, the number of bytes in each time slot is also fixed, thus the number of bytes in each time slot can be equivalent to the data transmission rate. Different modulation and coding schemes (such as downlink interval usage code DIUC) and MIMO modes are combined, and the data transmission rates corresponding to the combinations are sorted in the order from small to large, so as to acquire the following corresponding relationship table:

TABLE 1

| Downlink modulation and | | |
|---|---|---|
| coding scheme | | Data transmission |
| (such as DIUC) | MIMO mode | rate |
| DIUC1 | MIMO1 | V1 |
| DIUC2 | MIMO2 | V2 |
| DIUC3 | MIMO3 | V3 |
| . . . | . . . | . . . |

In table 1, V1≦V2≦V3 . . . , that is, as the data transmission rates increase gradually, the DIUC and the MIMO mode are combined differently. The process of adjusting the downlink modulation and coding scheme and the MIMO mode in the present invention is based on Table 1. In the adjustment process, when encountering different combinations and the same data transmission rate, a combination in which the MIMO mode is the STC mode is preferably selected in the available DIUC range to ensure the link reliability as far as possible.

Step 302: the Adaptive Modulation and Coding (AMC) module in the base station determines the maximal available modulation and coding scheme according to the downlink CINR reported by the terminal, and when the downlink modulation and coding scheme currently in use is greater than maximal available modulation and coding scheme, switches the downlink modulation and coding scheme currently in use to the maximal available modulation and coding scheme and the MIMO mode currently in use to the space-time coding mode;

The size of the modulation and coding scheme mentioned in the present invention is the amplitude of the corresponding data transmission rate when the modulation and coding scheme is the space-time coding mode, and the amplitude of the modulation and coding scheme should be selected according to the following rules:

1. The modulation and coding scheme with higher modulation order is greater than the one with lower modulation order, for example, 16QAM(CTC)½>QPSK(CTC)¾;

2. When the modulation orders are the same, the modulation and coding scheme with higher coding efficiency is greater than the modulation and coding scheme with lower coding efficiency, for example, 16QAM(CTC)¾>16QAM(CTC)½.

After determining the maximal available modulation and coding scheme, the AMC module judges whether the downlink modulation and coding scheme currently in use is greater than the maximal available modulation and coding or not, and if yes, switches the downlink modulation and coding scheme currently in use to the maximal available modulation and coding scheme and switches the MIMO mode currently in use to the space-time coding mode, otherwise, maintains the current downlink modulation and coding scheme and the MIMO mode unchanged.

Step 303: the hybrid automatic repeat request (HARQ) module in the base station collects the total number of packets and the number of valid packets in the total packets in each report period;

Since the channel conditions between different users and the base station may be different, in this step, the HARQ module collects the number of packets separately for each user. In order to avoid too high resource occupancy rate due to the base station frequently collecting the number of packets, a report period TH is set. When the report period TH is reached, the HARQ module collects the data packet information: the total number of packets M as well as the number of successfully transmitted packets in the M packets in this period N, and the successfully transmitted data packet is called valid data packet in the present invention.

In order to more accurately reflect the channel conditions, only the number of data packets transmitted for the first time is collected, and the number of the packets transmitted for the first time is taken as the total number of packets M, and the number of successfully transmitted valid packets N without retransmission is collected in these M packets.

Step 304: the base station judges whether the current downlink modulation and coding scheme and the MIMO mode are suitable for the current channel conditions or not according to the total number of packet and the number of valid data packets, and adjusts the current downlink modulation and coding scheme and the MIMO mode according to the maximal available modulation and coding scheme described above and the corresponding relationship table when determining that the current downlink modulation and coding scheme and the MIMO mode are not suitable for the current channel conditions.

Considering that frequent adjustments will result in too large system overhead and the system data transmission should be stable, in this embodiment, two switching decision periods are set: the first switching decision period (T_{UP}) and the second switching decision period (T_{DOWM}), accordingly, two switching thresholds are set: the first switching threshold (TH_{UP}) and the second switching threshold (TH_{DOWM}). Wherein, it is judged whether it needs to increase the data transmission rate or not in the first switching decision period, and it is judged whether it needs to decrease the data transmission rate or not in the second switching decision period. In order to increase the system throughput to the most extent on the basis of ensuring the stability of system transmission data, slow increase and fast decrease is applied, that is, T_{DOWM}<T_{UP}.

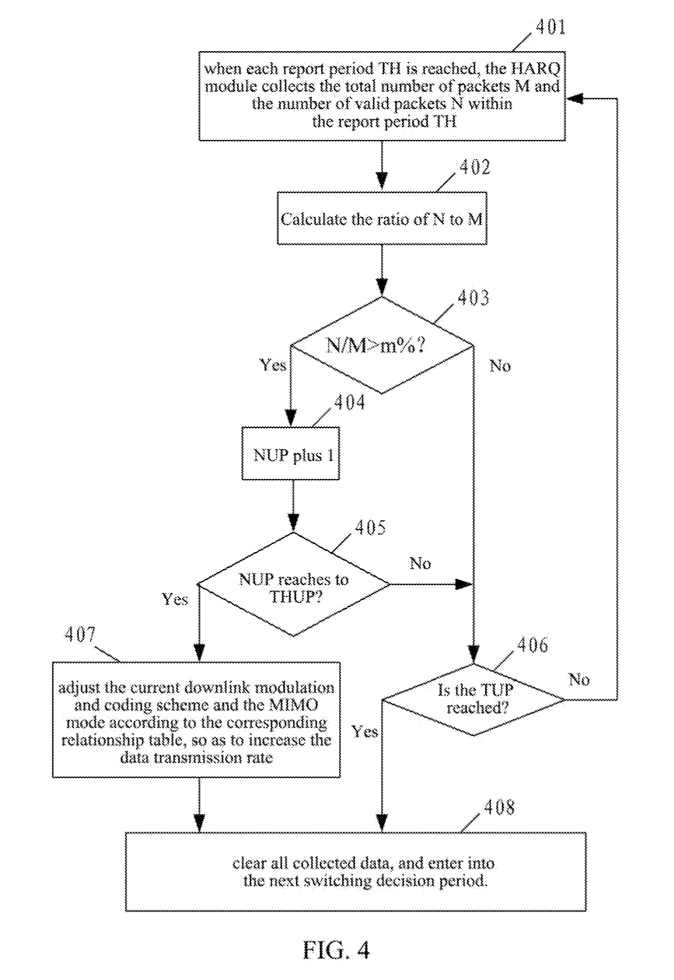

FIG. 4 is a flow chart of executing the adjustment method in the switching decision period T_{UP} in accordance with the present invention, and the method mainly comprises the following steps:

Step 401: when each report period TH is reached, the HARQ module in the base station collects the total number of packets M and the number of valid packets N within the report period TH;

Step 402: Calculate the ratio of the number of valid packets M to the total number of packets M in the report period TH to acquire the first ratio;

Steps 403˜404: determine whether the first ratio is greater than the first threshold (m %) or not, and if yes, increase the first times N_{UP} by 1, otherwise, proceed to step 406;

Wherein, the first threshold m % can be flexibly set according to the specific communication environment, the first times Nᵤₚ is initially set as 0.

Step 405: judge whether said first times N_{UP} reaches to the first switching threshold TH_{UP} or not, if yes, it means that the current downlink modulation and coding scheme and the MIMO mode are not suitable for the current channel conditions, proceed to step 407, otherwise, proceed to step 406;

Step 406: judge whether the first switching decision period T_{UP} is reached or not, and if yes, proceed to step 408, otherwise, return to step 401;

Step 407: adjust the current downlink modulation and coding scheme and the MIMO mode according to the maximal available modulation and coding scheme and the corresponding relationship table, so as to increase the data transmission rate;

Specifically, search the corresponding relationship table (Table 1) downwardly to find the entries whose data transmission rates are greater than the current data transmission rate and downlink modulation and coding schemes are no greater than the maximal available modulation and coding scheme, switch the current downlink modulation and coding scheme and the MIMO mode to the downlink modulation and code method and the MIMO mode in the first found entry.

Step 408: clear all collected data, and enter into the next switching decision period.

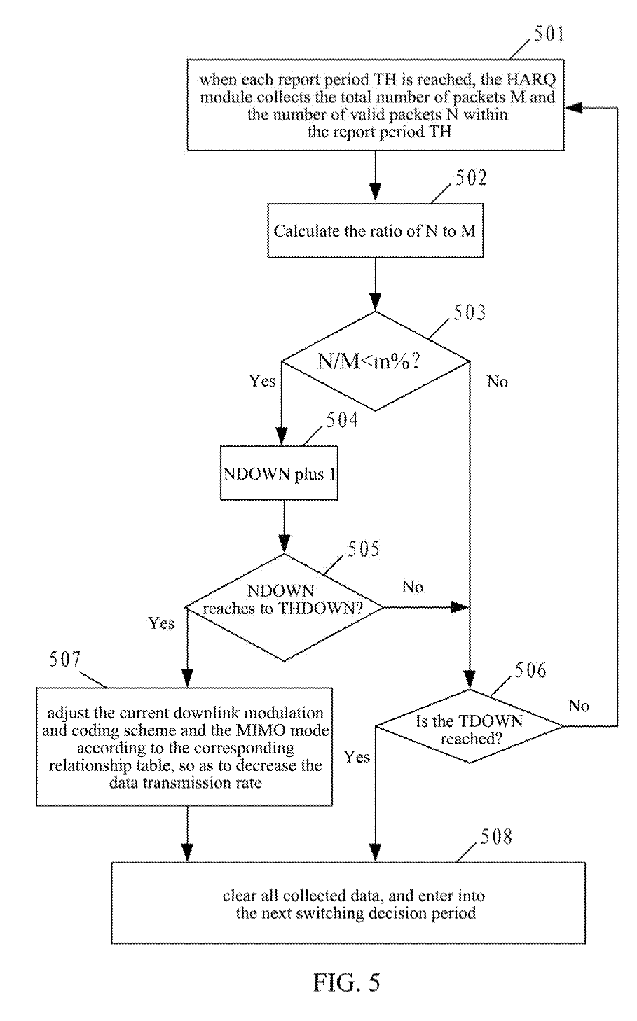

FIG. 5 is a flow chart of executing the adjustment method in the switching decision period T_{DOWN} in the present invention, and the adjustment method mainly comprises the following steps:

Step 501: when each report period TH is reached, the HARQ module in the base station collects the total number of packets M and the number of valid packets N within the report period TH;

Step 502: Calculate the ratio of the number of the valid packets N to the total number of packets M in the report period TH to acquire the second ratio;

Steps 503˜504: judge whether the second ratio is less than the second threshold (n %) or not, and if yes, increase the second times N_{DOWN} by 1, otherwise, proceed to step 506;

Wherein, the second threshold n % can be flexible set according to the specific communication environment, and the second times N_{DOWN} is initially set as 0.

Step 505: Judge whether the second times N_{DOWN} reaches the second switching threshold TH_{DOWN} or not, if yes, it means that the current downlink modulation and coding scheme and the MIMO mode are not suitable for the current channel conditions, proceed to step 507, otherwise, proceed to step 506;

Step 506: judge whether the second switching decision period T_{DOWN} is reached or not, and if yes, proceed to step 508, otherwise, return to step 501;

Step 507: adjust the current downlink modulation and coding scheme and the MIMO mode according to the maximal available modulation and coding scheme and the corresponding relationship table, so as to decrease the data transmission rate;

Specifically, search the corresponding relationship table (Table 1) upwardly to find the entries whose data transmission rates are lower than the current data transmission rate and downlink modulation and coding schemes are no greater than the maximal available modulation and coding scheme, switch the current downlink modulation and coding scheme and the MIMO mode to the downlink modulation and code method and the MIMO mode in the first found entry.

Step 508: clear all collected data, and enter into the next switching decision period.

In addition, if the HARQ module's statistical result reveals that the total number of packets is repeatedly zero for several times, then there is a possibility that the channel conditions suddenly deteriorate so that the data cannot be transmitted or the services are not transmitted, in this case, it also needs to decrease the data transmission rate so as to increase the channel gain as much as possible and to ensure the link reliability. It specifically comprises: collecting the times that the total number of packets is continuously zero to acquire the third times; when the third times reaches the third switching threshold, searching the corresponding relationship table upwardly to find the entries whose data transmission rates are lower than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in the first found entry.

In the following, the base station device for implementing the aforementioned method is provided.

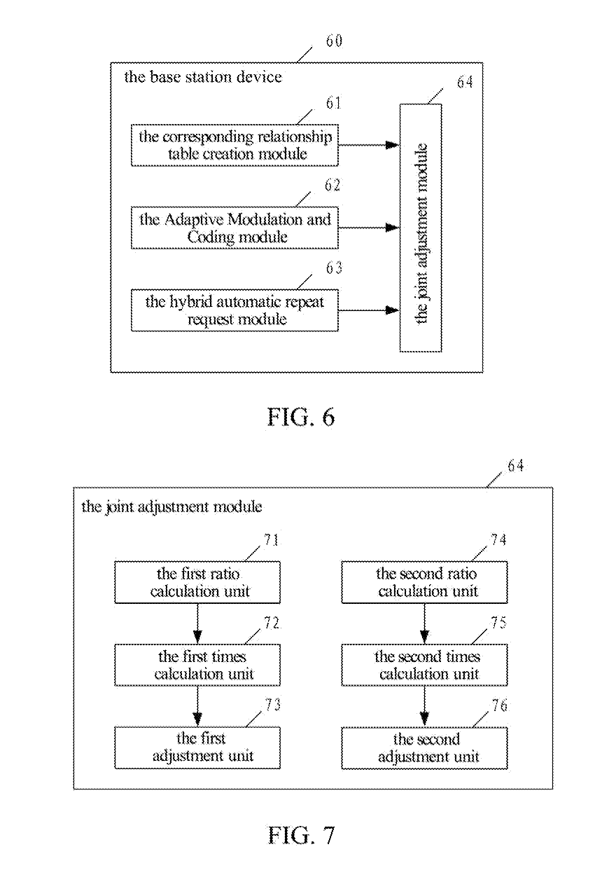

Refer to FIG. 6, the base station device 60 in accordance with the embodiment of the present invention comprises:

The corresponding relationship table creation module 61, configured for creating a corresponding relationship table of the data transmission rates and the combinations of the downlink modulation and coding schemes and the MIMO modes, and sorting the data transmission rates in the corresponding relationship table in the order from small to large.

In the case that the modulation and coding scheme and the MIMO mode are fixed, the number of bytes in each time slot is also fixed, thus the number of bytes in each time slot can be equivalent to the data transmission rate. Different modulation and coding schemes and MIMO modes are combined, and the data transmission rates corresponding to the combinations are sorted in the order from small to large so as to acquire the corresponding relationship table shown as Table 1.

The AMC module 62, configured for determining the maximal available modulation and coding scheme according to the downlink carrier-to-interference-and-noise ratio reported by the terminal, and when the modulation and coding scheme currently in use is greater than the maximal available modulation and coding scheme, switching the downlink modulation and coding scheme in use to the maximal available modulation and coding scheme, and switching the MIMO mode currently in use to the space-time coding mode;

The hybrid automatic repeat request (HARM) module 63, configured for collecting the total number of packets in each report period and the number of valid data packets in the total packets.

Since the channel conditions between different users and the base station may be different, the HARQ module 63 collects the number of packets separately for each user. In order to avoid too high resource occupancy rate due to the base station frequently collecting the number of packets, a report period TH is set. When the report period TH is reached, the HARQ module 63 collects the data packet information: the total number of packets M as well as the number of successfully transmitted packets in the M packets in N this period, and the successfully transmitted data packet is called valid data packet in the present invention.

In order to more accurately reflect the channel conditions, only the number of data packets transmitted for the first time is collected, and the number of the packets transmitted for the first time is taken as the total number of packets M, and the number of successfully transmitted valid packets N without retransmission N is collected in these M packets.

The joint adjustment module 64, configured for judging whether the current downlink modulation and coding scheme and the MIMO mode are suitable for the current channel conditions or not according to the total number of packets and the number of valid packets, and when determining that the current downlink modulation and coding scheme and the MIMO mode are not suitable for the current channel conditions, adjusting the downlink modulation and coding scheme and the MIMO mode currently in use according to the maximal available modulation and coding scheme described above and the corresponding relationship table.

Considering that frequent adjustments will result in too large system overhead and the system data transmission should be stable, in this embodiment, two switching decision periods are set: the first switching decision period (T_{UP}) and the second switching decision period (T_{DOWM}), accordingly, two switching thresholds are set: the first switching threshold (TH_{UP}) and the second switching threshold (TH_{DOWM}). Wherein, it is to judge whether it needs to increase the data transmission rate or not in the first switching decision period, and it is to judge whether it needs to decrease the data transmission rate or not in the second switching decision period. In order to increase the system throughput to the most extent on the basis of ensuring the stability of system transmission data, slow increase fast decrease, that is, T_{DOWM}<T_{UP}, is applied.

Refer to FIG. 7, the joint adjustment module 64 specifically comprises:

The first ratio calculation unit 71, configured for calculating the ratio of the number of valid packets to the total number of packets in each report period in the first switching decision period to acquire the first ratio;

The first times calculation unit 72, configured for collecting the times that the first ratio is greater than the first threshold to acquire the first times; and

The first adjustment unit 73, configured for: when the first times reaches to the first switching threshold, it is to determine that the current downlink modulation and coding scheme and the MIMO mode are not suitable for the current channel conditions, searching the corresponding relationship table downwardly to find the entries whose data transmission rates are greater than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in the first found entry.

The second ratio calculation unit 74, configured for calculating the ratio of the number of valid packets to the total number of packets in each report period in the second switching decision period to acquire the second ratio;

The second times calculation unit 75, configured for collecting the times that the second ratio is less than the second threshold to acquire the second times; and

The second adjustment unit 76, configured for: when the second times reaches to the second switching threshold, determining that the current downlink modulation and coding scheme and the MIMO mode are not suitable for the current channel conditions, searching the corresponding relationship table upwardly to find the entries whose data transmission rates are lower than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in the first found entry.

In addition, if the HARQ module's statistical result reveals that the total number of packets is repeatedly zero for several times, then there is a possibility that the channel conditions suddenly deteriorate so that the data cannot be transmitted or the services are not transmitted, in this case, it also needs to decrease the data transmission rate so as to increase the channel gain as much as possible and to ensure the link reliability. Therefore, the joint adjustment module 64 also comprises:

The third times calculation unit (not shown in the figure), configured for collecting the times that the total number of packets is continuously zero to acquire the third times;

The third adjustment unit (not shown in the figure), configured for: when the third times reaches to the third switching threshold, determining that the current downlink modulation and coding scheme and the MIMO mode are not suitable for the current channel conditions, searching the corresponding relationship table upwardly to find the entries whose data transmission rates are lower than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in the first found entry.

To better illustrate the beneficial effects of the present invention, Table 1 is instantiated as the following Table 2:

TABLE 2

| Downlink modulation | | The number of bytes in each time |
|---|---|---|
| and coding scheme | MIMO | slot (comparable to the data |
| (DIUC) | mode | transmission rate) |
| QPSK (CTC) ½ | STC | 6 |
| QPSK (CTC) ¾ | STC | 9 |
| QPSK (CTC) ½ | SM | 12 |
| 16QAS (CTC) ½ | STC | 12 |
| QPSK (CTC) ¾ | SM | 18 |
| 16QAS (CTC) ¾ | STC | 18 |
| 64QAS (CTC) ½ | STC | 18 |
| 16QAS (CTC) ½ | SM | 24 |
| 64QAS (CTC) ⅔ | STC | 24 |
| 64QAS (CTC) ¾ | STC | 27 |
| 64QAS (CTC) ⅚ | STC | 30 |
| 16QAS (CTC) ¾ | SM | 36 |
| 64QAS (CTC) ½ | SM | 36 |
| 64QAS (CTC) ⅔ | SM | 48 |
| 64QAS (CTC) ¾ | SM | 54 |
| 64QAS (CTC) ⅚ | SM | 60 |

Assume the current downlink modulation and coding scheme is: 16 QAM (CTC) ½, the downlink MIMO mode is: SM mode, and the downlink CINR reported by the terminal is fixed. If the download performance of the terminal at this time is not good, it needs to lower the data transmission rate. Based on the existing technology, the current downlink modulation and coding scheme 16QAM (CTC) ½ keeps unchanged, and the downlink MIMO mode is adjusted as: the STC mode.

The technical scheme of the present invention searches the Table 2 from the current entry (16QAM (CTC) ½, SM) in Table 2 upwardly to find the first entry whose data transmission rate is less than the current data transmission rate (24) and the downlink modulation and coding scheme is no greater than the maximal available modulation and coding scheme (16 QAM (CTC) ½), and the searching result is: QPSK (CTC) ¾, SM, and switch the current downlink modulation and coding scheme and the MIMO mode to: QPSK (CTC) ¾, SM. In the subsequent process, the HARQ technology is used to judge whether the current downlink modulation and coding scheme and the downlink MIMO mode are suitable for the current channel conditions or not, if yes, it can be found from Table 2 that QPSK (CTC) ¾, SM mode has 50% higher data transmission rate than the 16 QAM (CTC) ½, STC mode; otherwise, switch to 16 QAM (CTC) ½, STC mode.

Based on the above comparison, it can be seen that the present invention can effectively improve the data transmission rate and spectrum efficiency, thereby enhancing the link reliability and system throughput.

It can be understood by those skilled in the field that some or all steps in the abovementioned method can be fulfilled by instructing the relevant hardware components with a program, and said program is stored in a computer readable storage media such as read only memory, magnetic disk or optical disk. Optionally, some or all steps in the above-mentioned embodiment can be implemented with one or more integrated circuits. Correspondingly, each module/unit in the abovementioned embodiment can be implemented in the form or hardware or in the form of software function module, or their combinations.

Finally, it should be noted that the above embodiments are used to illustrate rather than restrict the technical scheme of the present invention; it should be understood by those skilled in the field that the description of the above scheme can be modified or improved. Without departing from the spirit and essence of the present invention, all these types of modification or variations should belong to the scope of the claims of the present invention.

### INDUSTRIAL APPLICABILITY

The method for adjusting the downlink modulation and coding scheme and the downlink MIMO mode and the base station device thereof provided in the present invention use the HARQ technology to judge whether the current downlink are suitable for the current channel conditions or not, and jointly adjust the downlink modulation and coding scheme and the downlink MIMO mode, thus efficiently improve the link reliability and system throughput.

What is claimed is:

1. An adjustment method for a downlink modulation and coding scheme and a multiple input multiple output (MIMO) mode, comprising:
establishing a corresponding relationship table of data transmission rates and combinations of the downlink modulation and coding schemes and the MIMO modes, and sorting the data transmission rates in the corresponding relationship table in an order from small to large;
determining a maximal available modulation and coding scheme according to a downlink carrier-to-interference-and-noise-ratio reported by a terminal, and when the downlink modulation and coding scheme currently in use is greater than the maximal available modulation and coding scheme, switching the downlink modulation and coding scheme currently in use to the maximal available modulation and coding scheme, and switching the MIMO mode currently in use to a space-time coding mode;
collecting a total number of packets in each report period and a number of valid data packets in the total packets; and
judging whether the current downlink modulation and coding scheme and the MEMO mode are suitable for current channel conditions or not according to the total number of packets and the number of valid packets, and adjusting the downlink modulation and coding scheme and the MIMO mode currently in use according to the maximal available modulation and coding scheme and the corresponding relationship table when determining that the current downlink modulation and coding scheme and the MIMO mode are not suitable for the current channel conditions.

2. The adjustment method of claim 1, wherein, the step for judging whether the current downlink modulation and coding scheme and the MIMO mode are suitable for the current channel conditions or not according to the total number of packets and the number of valid packets, and adjusting the downlink modulation and coding scheme and the MIMO mode currently in use according to the maximal available modulation and coding scheme and the corresponding relationship table when determining that the current downlink modulation and coding scheme and the MIMO mode are not suitable for the current channel conditions comprises: calculating a ratio of the number of valid packets to the total number of packets in each report period in a first switching decision period to acquire a first radio;
collecting a times that the first ratio is greater than a first threshold to acquire a first times; and
when the first times reaches to a first switching threshold, determining that the current downlink modulation and coding scheme and the MIMO mode are not suitable for the current channel conditions, searching the corresponding relationship table downwardly to find entries whose data transmission rates are greater than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in a first found entry.

3. The adjustment method of claim 2, wherein, the step for judging whether the current downlink modulation and coding scheme and the MIMO mode are suitable for the current channel conditions or not according to the total number of packets and the number of valid packets, and adjusting the downlink modulation and coding scheme and the MIMO mode currently in use according to the maximal available modulation and coding scheme and the corresponding relationship table when determining that the current downlink modulation and coding scheme and the MIMO mode are not suitable for the current channel conditions also comprises: calculating a ratio of the number of valid packets to the total number of packets in each report period in a second switching decision period to acquire a second radio;
collecting a times that the second ratio is less than a second threshold to acquire a second times; and
when the second times reaches to a second switching threshold, determining that the current downlink modulation and coding scheme and the MIMO mode are not suitable for the current channel conditions, searching the corresponding relationship table upwardly to find entries whose data transmission rates are lower than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in a first found entry.

4. The adjustment method of claim 3, wherein, the step for judging whether the current downlink modulation and coding scheme and the MIMO mode are suitable for the current channel conditions or not according to the total number of packets and the number of valid packets, and adjusting the downlink modulation and coding scheme and the MIMO mode currently in use according to the maximal available modulation and coding scheme and the corresponding relationship table when determining that the current downlink modulation and coding scheme and the MEMO mode are not suitable for the current channel conditions also comprises:
collecting a times that the number of packets is zero to acquire a third times; and
when the third times reaches to a third switching threshold, determining that the current downlink modulation and coding scheme and the MIMO mode are not suitable for the current channel conditions, searching the corresponding relationship table upwardly to find entries whose data transmission rates are lower than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in a first found entry.

5. The adjustment method of claim 3, wherein,
the first switching decision period is greater than the second switching decision period.

6. The adjustment method of claim 1, wherein,
the total number of data packets is a number of non-retransmitted packets collected by a base station in one report period.

7. A base station device, comprising:
a corresponding relationship table creation module, configured for creating a corresponding relationship table of data transmission rates and combinations of downlink modulation and coding schemes and MIMO modes, and sorting the data transmission rates in the corresponding relationship table in an order from small to large;
an Adaptive Modulation and Coding (AMC) module, configured for determining a maximal available modulation and coding scheme according to a downlink carrier-to-interference-and-noise-ratio reported by a terminal, and when the modulation and coding scheme currently in use is greater than the maximal available modulation and coding scheme, switching the downlink modulation and coding scheme currently in use to the maximal available modulation and coding scheme, and switching the MIMO mode currently in use to a space-time coding mode;
a hybrid automatic repeat request module, configured for collecting a total number of packets in each report period and a number of valid data packets in the total packets; and
a joint adjustment module, configured for judging whether the current downlink modulation and coding scheme and the MIMO mode are suitable for current channel conditions or not according to the total number of packets and the number of valid packets, and when determining that the current downlink modulation and coding scheme and the MIMO mode are not suitable for the current channel conditions, adjusting the downlink modulation and coding scheme and the MIMO mode currently in use according to the maximal available modulation and coding scheme and the corresponding relationship table.

8. The base station device of claim 7, wherein, the joint adjustment module comprises:
a first ratio calculation unit, configured for calculating a ratio of the number of valid packets to the total number of packets in each report period in a first switching decision period to acquire a first ratio;
a first times calculation unit, configured for collecting a times that the first ratio is greater than a first threshold to acquire a first times; and
a first adjustment unit, configured for: when the first times reaches to a first switching threshold, determining that the current downlink modulation and coding scheme and the MIMO mode are not suitable for the current channel conditions, searching the corresponding relationship table downwardly to find entries whose data transmission rates are greater than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in a first found entry.

9. The base station device of claim 8, wherein, the joint adjustment module also comprises:
a second ratio calculation unit, configured for calculating a ratio of the number of valid packets to the total number of packets in each report period in a second switching decision period to acquire a second ratio;
a second times calculation unit, configured for collecting a times that the second ratio is less than a second threshold to acquire a second times; and
a second adjustment unit, configured for: when the second times reaches to a second switching threshold, determining that the current downlink modulation and coding scheme and the MIMO mode are not suitable for the current channel conditions, searching the corresponding relationship table upwardly to find entries whose data transmission rates are lower than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in a first found entry.

10. The base station device of claim 9, wherein, the joint adjustment module also comprises:
a third times calculation unit, configured for collecting a times that the total number of packets is continuously zero to acquire a third times; and
a third adjustment unit, configured for: when the third times reaches to a third switching threshold, determining that the current downlink modulation and coding scheme and the MIMO mode are not suitable for the current channel conditions, searching the corresponding relationship table upwardly to find entries whose data transmission rates are lower than the current data transmission rate and downlink modulation and coding schemes are no greater than the maximal available modulation and coding scheme, and switching the current downlink modulation and coding scheme and the MIMO mode to the downlink modulation and coding scheme and the MIMO mode in a first found entry.

11. The adjustment method of claim 2, wherein,
the total number of data packets is the number of non-retransmitted packets collected by the base station in one report period.

12. The adjustment method of claim 3, wherein,
the total number of data packets is the number of non-retransmitted packets collected by the base station in one report period.

13. The adjustment method of claim 4, wherein,
the total number of data packets is the number of non-retransmitted packets collected by the base station in one report period.

14. The adjustment method of claim 5, wherein,
the total number of data packets is the number of non-retransmitted packets collected by the base station in one report period.
